(19) United States
(12) Patent Application Publication
(10) Pub. No.: US 2012/0091970 A1
(43) Pub. Date: Apr. 19, 2012

(54) CHARGING EQUIPMENT OF VARIABLE FREQUENCY CONTROL FOR POWER FACTOR

(75) Inventors: Young Jin Cho, Seoul (KR); Kyu Bum Han, Gyunggi-do (KR)

(73) Assignee: SAMSUNG ELECTRO-MECHANICS CO., LTD., Gyunggi-do (KR)

(21) Appl. No.: 12/979,731

(22) Filed: Dec. 28, 2010

(30) Foreign Application Priority Data
Oct. 19, 2010 (KR) 1020100101979

(51) Int. Cl. H02J 7/04

(52) U.S. Cl. 320/160

(57) ABSTRACT

Disclosed herein is a charging equipment of variable frequency control for power factor. In addition, the present invention relates to a charging equipment of variable frequency control for power factor including: an AC-DC converter converting AC power into DC power; a DC-DC converter converting DC power output from the power factor calibration circuit into DC power for charging a battery and outputting the converted DC power; and a power factor calibration circuit calibrating power factor by the operation of the switching device and outputting the calibrated power factor; and a power factor calibration circuit controller performing the switching control by varying the frequency of the pulse signal when performing a switching control by modulating a pulse width of a pulse signal on the switching devices of the power factor calibration circuit, thereby making it possible to maintain the power factor even in the light load status.

### CROSS REFERENCE TO RELATED APPLICATION

This application claims the benefit of Korean Patent Application No. 10-2010-0101979, filed on Oct. 19, 2010, entitled “Charging Equipment Of Variable Frequency Control For Power Factor”, which is hereby incorporated by reference in its entirety into this application.

### BACKGROUND OF THE INVENTION

1. Technical Field

The present invention relates to a charging equipment of variable frequency control for power factor.

2. Description of the Related Art

Generally, a battery used as a main power supply in an electric car discharges charged voltage when the electric car is travelling, such that the battery should be essentially charged after travelling a predetermined distance for a predetermined time.

A method of charging a battery that is a main power supply of an electric car is largely classified depending on a system or charging current classifying type. The system classifying method is classified into an on-board type in which a charging equipment is included in an electric car and an off-board charging type using a charging equipment separately mounted at the outside.

In addition, the charging current type is divided into a general charging type that performs charging with current of 20 A or less over a long period of time and a rapid charging type that performs charging with current of 30 A or more over a short period of time.

Generally, the general charging type uses an on-board charging equipment mounted in a car and the rapid charging type uses an off-board charging equipment separately mounted at the outside.

In the charging type of the electric car as described above, the on-board charging equipment is configured to include a power factor calibration circuit, a power factor calibration circuit controller, a DC-DC converter, and a charging controller.

In this configuration, the power factor calibration circuit controller senses voltage and current output from a power factor calibration circuit to perform a switching control on switching devices of the power factor calibration circuit, thereby maintaining power factor.

In the charging equipment as described above, when a battery status is widely changed from a heavy load status (having a small resistance value) supplied with a large amount of power to a light load status (having a large resistance value) supplied with a small amount of power, there is a need for high efficiency in a wide load region.

However, in the charging equipment according to the prior art, since the power factor calibration circuit controller switches the switching device of the power factor calibration circuit by using a pulse width modulation scheme still having the same switching frequency as the heavy load status in the light load status, the power consumption in the power factor calibration circuit is relatively large, thereby more significantly degrading the power conversion efficiency in the light load than in the heavy load.

### SUMMARY OF THE INVENTION

The present invention has been made in an effort to provide a charging equipment of variable frequency control for power factor capable of improving power conversion efficiency (power factor) by sensing a load status of a battery to operate switching devices with a switching frequency relatively lower in a light load stat than that in a heavy status.

According to a preferred embodiment of the present invention, there is provided a charging equipment of variable frequency control for power factor, including: an AC-DC converter receiving AC power and converting it into DC power and outputting it; a power factor calibration circuit including a switching device and calibrating the power factor of the DC power output from the AC-DC converter by the switching operation of the switching device and outputting it; a DC-DC converter converting DC power output from the power factor calibration circuit into DC power for charging a battery and outputting the converted DC power; and a power factor calibration circuit controller performing the switching control by varying the frequency of the pulse signal according to a load status of a battery output from a battery management system when performing a switching control on the switching devices of the power factor calibration circuit by modulating a pulse width of a pulse signal according to the DC power output from the power factor calibration circuit.

The power factor calibration circuit controller may vary the frequency of the pulse signal in order to have a switching frequency relatively lower in a heavy load status than in a case where the load status of the battery is in a light load status.

The power factor calibration circuit controller may include: a pulse width modulator outputting a pulse signal of which the pulse width is modulated in order to perform a switching control on the switching device of the power factor calibration circuit; and a pulse frequency modulator varying a frequency of the pulse signal output from the pulse width modulator according to the load status of the battery output from the battery management system to perform the switching control on the switching device.

The pulse frequency modulator may include: a comparator receiving output voltage and reference voltage in proportion to the load status from the battery management system to compare the input signals and output them; a transistor having a first terminal connected to power voltage and a second terminal and a third terminal connected to ground voltage; a capacitor connected between the first and second terminals of the transistor in parallel; a latch connected to the output terminal of the comparator and the first terminal of the transistor and outputting the pulse signal of which the frequency is varied; and a delayer delaying the pulse signal of which the frequency is varied to provide it to the third terminal of the transistor.

The charging equipment of variable frequency control for power factor may include a filter unit receiving the AC power to remove high frequency component and output it to the AC-DC converter.

The charging equipment of variable frequency control for power factor may further include a charging filter unit receiving the DC power output from the DC-DC converter to remove the high frequency component and output it to the battery.

The AC-DC converter may include a bridge full-wave rectification circuit in which four diodes are connected in a bridge scheme.

The power factor calibration circuit may include: an inductor connected to one terminal of the AC-DC converter in series; a blocking diode connected to the inductor in series in a positive direction toward a load terminal and blocking current in a reverse direction; a switching transistor having a first terminal connected to the output terminal of the inductor and a second terminal connected to the other terminal of the AC-DC converter and performing a function as the switching device by performing the turn-on/off operation according to the switching control signal applied through the third terminal from the power factor calibration circuit controller; and a storage capacitor connected between the output terminal of the blocking diode and the other terminal of the AC-DC converter.

The DC-DC converter may include: a DC-AC converter converting DC power output from the power factor calibration circuit into AC power; a contactless transformer increasing and reducing AC power output from the AC-DC converter and outputting the AC power; and an AC-DC converter converting the increased or reduced AC power output from the contactless transformer into DC power for the battery and outputting the converted DC power.

The DC-AC converter may include: a pair of switching transistors having a first terminal connected to one terminal of the output side of the power factor calibration circuit and a second terminal connected to each of the two terminals of the contactless transformer; another pair of switching transistors having a first terminal connected to each of the two terminals of the contactless transformer and a second terminal connected to the other side terminal of the power factor calibration circuit; and four anti-parallel diodes reversely connected between the first terminal and the second terminal of each of the switching transistors in order to prevent current from reflowing from the winding of the secondary side of the contactless transformer.

### BRIEF DESCRIPTION OF THE DRAWINGS

FIG. 1 is a block diagram of a charging equipment of variable frequency control for power factor according to a first preferred embodiment of the present invention;

FIG. 2 is a circuit diagram of a charging equipment of variable frequency control for power factor of FIG. 1;

FIG. 3 is a waveform diagram of a continuous current mode (CCM) of a power factor calibration circuit of FIG. 2;

FIG. 4 is a waveform diagram of a discontinuous current mode (DCM) of a power factor calibration circuit of FIG. 2;

FIG. 5 is a waveform diagram showing a pulse signal output from a power factor calibration circuit controller according to the change in current I_{Load} flowing into a battery;

FIG. 6 is an exemplified diagram of a waveform generated in a DC-DC converter of FIG. 2; and

FIG. 7 is a configuration diagram of a pulse frequency modulator of FIG. 1.

### DESCRIPTION OF THE PREFERRED EMBODIMENTS

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, when it is determined that the detailed description of the known art related to the present invention may obscure the gist of the present invention, the detailed description thereof will be omitted.

Hereinafter, preferred embodiments of the present invention will be described in detail with reference to the accompanying drawings.

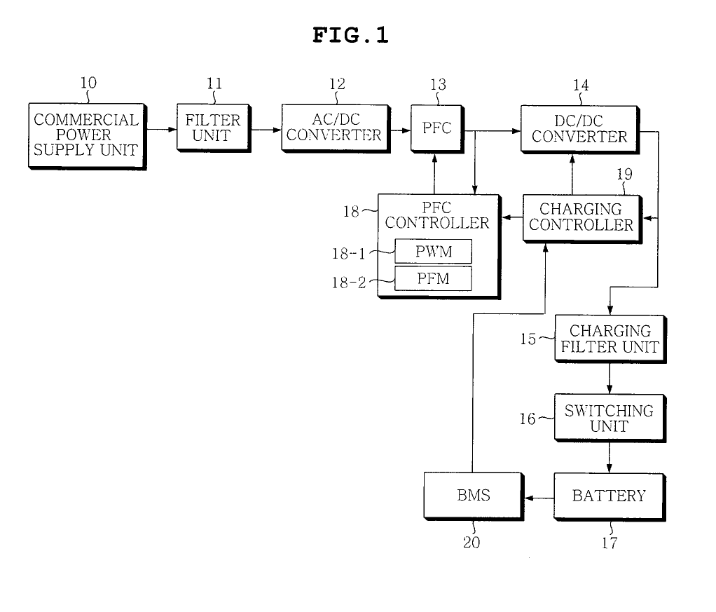

FIG. 1 is a block diagram of a charging equipment of variable frequency control for power factor according to a first preferred embodiment of the present invention.

Referring to FIG. 1, a charging equipment of variable frequency control for power factor according to a first preferred embodiment of the present invention is configured to include a commercial power supplier 10, a filter unit 11, an AC-DC converter 12, a power factor calibration circuit 13, a DC-DC converter 13, a charging filter unit 15, a switching unit 16, a battery 17, a power factor calibration circuit controller 18, a charging controller 19, and a battery management system (BMS) 20. The power factor calibration circuit controller 18 is configured to include a pulse width modulator 18-1 and a pulse frequency modulator 18-2.

In this configuration, the commercial power supply unit 10 is connected to a grid power supply to receive AC power from a transmitting line and supply it to the filter unit 11.

The filter unit 11 is connected to the commercial power supply unit 10 to remove interference and noise of unnecessary high frequency signal of AC power input from the outside and pass through it. As the filter unit 11, an electromagnetic interference (EMI) filter may be used.

An input terminal of the AC-DC converter 12 is connected to an output terminal of the filter unit 11. The AC-DC converter 12 receives AC power passing through the filter unit 11, which converts it into DC power and outputs it.

The power factor calibration circuit (PFC) 13 controls power factor to minimize a phase loss due to a phase difference between a current waveform and a voltage waveform of the AC power when the AC power is rectified by passing through the AC-DC converter 12.

Next, the DC-DC converter 14 is connected to the output terminal of the power factor calibration circuit 13 to receive the DC power output from the power factor calibration circuit 13 and convert it into the AC power suitable for the battery charging of the electric car and output it.

As the DC-DC converter 14, a quasi-resonant flyback converter, a forward converter, a full-bridge converter, and a half-bridge converter, or the like, may be used.

The charging filter unit 15 is connected to the DC-DC converter 14 to remove the interference and noise of the unnecessary high frequency signal of the DC power and pass through it. The charging filter unit 15 may be selectively provided.

The switching unit 16 is connected between the DC-DC converter 14 or the charging filter unit 15 and the battery 17 to conduct or short-circuit the electrical connection between the DC-DC converter 14 or the charging filter unit 15 and the battery 17.

The battery 17 uses a secondary battery as an apparatus for charging and discharging power necessary for an electric car.

Meanwhile, the power factor calibration circuit controller 18 is connected to the output terminal of the power factor calibration circuit 13 to sense a DC value output from the power factor calibration circuit 13, thereby performing a control to switch switching devices included in the power factor calibration circuit 13.

In this case, the power factor calibration circuit controller 18 receives load information depending on the battery charging status via the charging controller 19 from the battery management system 20 or directly receives the load information on the battery charging status to drive the switching device of the power factor calibration circuit 13 by using the pulse width modulation using a high frequency in the case of a heavy load (that is, using a variable frequency pulse width control performing a pulse width control while varying a frequency to a high frequency) and to drive the switching device of the power factor calibration circuit 13 by using the pulse width modulation using a low frequency in a light load status (that is, using a variable frequency pulse width control performing a pulse width control while varying a frequency to a low frequency), thereby keeping power factor while suppressing the switching loss due to the unnecessarily high switching frequency in the light load status.

That is, the power factor calibration circuit controller 18 may control the pulse width (duty ratio) and the frequency through a pulse width modulator (PWM) 18-1 and a pulse frequency modulator (PFM) 18-2 including a square wave for control applied to the switching device of the power factor calibration circuit 13 according to the load status of the battery.

In detail, the pulse width modulation (PWM) 18-1 includes a semiconductor device and controls the pulse width of a voltage or current waveform in the square wave type according to the switching speed of the semiconductor device.

On the other hand, the pulse frequency modulator (PFM) 18-2 controls the frequency of the voltage or current waveform in the square wave type according to the switching speed of the semiconductor device.

In this case, the pulse frequency modulator 18-1 generates and outputs the square wave control signal of the high frequency in the heavy load status and generates and outputs the square wave control signal of the low frequency in the light load status, thereby keeping the power factor while suppressing the switching loss due to the unnecessarily high switching frequency in the light load status.

In this case, the pulse width control may be first performed by the pulse width modulator (PWM) 18-1 and then, the frequency control may be performed by the pulse frequency modulator (PFM) 18-2 or the frequency control may be performed by the pulse frequency modulator 18-2 and then, the pulse width control may be performed by the pulse width modulator 18-1.

Generally, when considering the trend that the battery 17 is rapidly changed from the heavy load status to the light heavy status, it is more preferable to use the former scheme capable of tracing the trend well.

Meanwhile, the charging controller 19 senses the DC value output from the DC-DC converter 14 to control the DC-DC converter 14.

The charging controller 19 receives the load status information of the battery 17 transmitted from the battery management system 20 and transmits it to the power factor calibration circuit controller 18.

The charging controller 19 determines the load status of the battery 17 transmitted from the battery management system 20 to control the power factor calibration circuit controller 18 in the case of the heavy load in order to increase the frequency of the control signal output from the power factor calibration circuit 13 and control the power factor calibration circuit controller 18 to lower the frequency of the control signal output from the power factor calibration circuit controller 13 in the case of the light load.

In addition, the charging controller 19 receives whether the battery 17 is connected to the charging equipment from the battery management system 20 and the charging voltage to perform the charging by turning-on the switching unit 16 when the charging voltage is a reference value or less and to turn-on the switching unit 16 when the charging voltage is a reference value or more to disconnect the electrical connection between the DC-DC converter 14 and the battery 17.

Next, the battery management system 20 manages the general operation at the time of charging the battery 17 and senses the load status of the battery 17 to transmit it to the charging controller 19 or the power factor calibration circuit controller 18.

The charging equipment of variable frequency control configured as described above senses the load status to drive the switching device of the power factor calibration circuit 13 with the high frequency in the heavy load status and operates the switching device of the power factor calibration circuit 13 with the low frequency in the light load status to lower the switching frequency, thereby keeping the power factor while suppressing the switching loss.

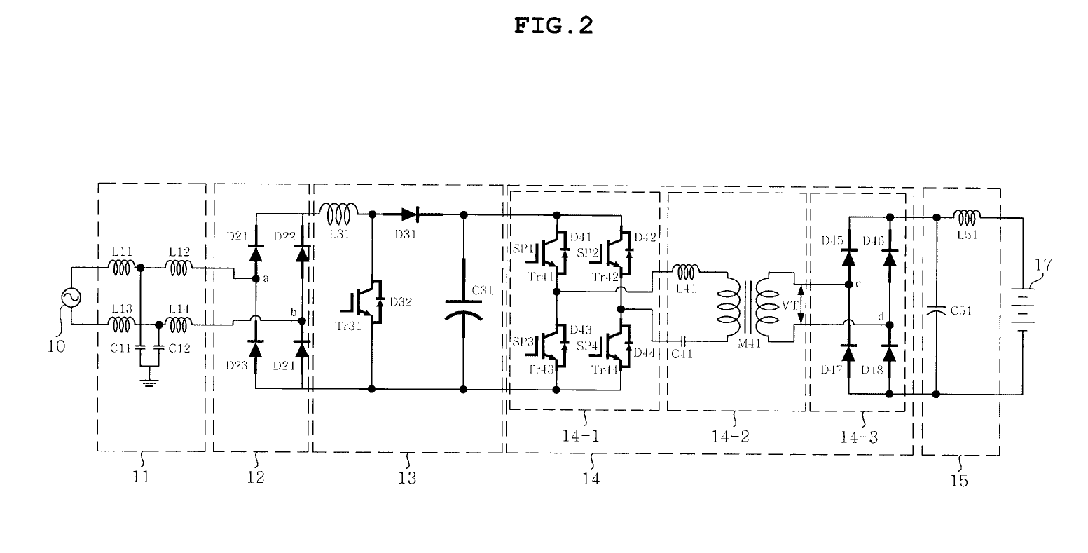

FIG. 2 is a block diagram of a charging equipment of variable frequency control for power factor according to a first preferred embodiment of the present invention.

Referring to FIG. 2, the filter unit 11 configuring the charging equipment of variable frequency control for power factor of the present invention is configured to include two inductors L11 and L12 connected to one terminal of the commercial power supply unit 10 in series, two inductors L13 and L14 connected to the other terminal of the commercial power supply unit 10 in series, a capacitor C11 connected between the inductors L11 and L12 and the ground, and a capacitor C12 between the inductors L13 and L14 and the ground.

As described above, the filter unit 11 connects the inductors L11, L12, L13, and L14 to the commercial power supply unit 10 in series and connects the capacitors C11 and C12 thereto in parallel, thereby removing the interference and noise of the unnecessary high frequency signal of the AC power input from the outside and passing through it.

In this configuration, the filter unit 11 is implemented in a scheme in which an inductor, a capacitor, and an inductor are sequentially connected to each other, but it may be implemented by only the inductor or may be implemented by a scheme in which the capacitor is connected to the inductor.

Next, the AC-DC converter 12 is configured of a bridge full-wave rectification circuit in which four diodes D21, D22, D23, and D24 are connected in a bridge scheme, wherein the bridge full-wave rectification circuit performs the full-wave rectification on the AC power periodically changed in positive and negative directions to convert it into the DC power having the full-wave rectification waveform in one direction.

In detail, when a positive current is applied to a first terminal a of the bridge full-wave rectification circuit, the first and fourth diodes D21 and D24 are turned-on to pass through the positive current and when a negative current is applied to a second terminal b of the bridge circuit, the second and third diodes D22 and D23 are turned-on to pass through the negative current.

Therefore, when loads are connected between both terminals of the bridge full-wave rectification circuit of the AC-DC converter 120, i.e., between the first terminal a and the second terminal b, the current passing through the bridge circuit constantly flows from the first terminal a into the second terminal b at all times. That is, the direction of current is always maintained constantly.

Next, the power factor calibration circuit 13 includes an inductor L31 connected to one terminal of the AC-DC converter 12 in series, a blocking diode D31 connected to the inductor L31 in a positive direction toward a load terminal and blocking current flowing in a reverse direction, a switching transistor Tr31 whose collector terminal is connected to the output terminal of the inductor L31, emitter terminal is connected to the other terminal of the AC-DC converter 12, and base terminal is connected to the power factor calibration circuit controller 18 to repeat the turn-on/off operation according to the variable frequency pulse width control signal output from the power factor calibration circuit controller 18, and a storage capacitor C31 connected between the output terminal of the diode D31 and the other terminal of the AC-DC converter 12.

The diode D31 is reversely connected between the collector terminal and the emitter terminal of the switching transistor Tr31 in parallel.

In the above-mentioned configuration, the power factor calibration circuit 13 receives DC voltage pulsated from the AC-DC converter 12.

When the switching transistor Tr31 is turned-on, electromagnetic energy is accumulated in the electromagnetic field of the inductor L31 by flowing current via the inductor L31 and the switching transistor Tr31 from the AC-DC converter 12.

To the contrary, when the switching transistor Tr31 is turned-off, the electromagnetic energy of the inductor L31 moves to the storage capacitor C31 by flowing current via the inductor L31 and the blocking diode D31.

The output from the power factor calibration circuit 13 is DC voltage across the storage capacitor C31 controlled by the power factor calibration circuit controller 18.

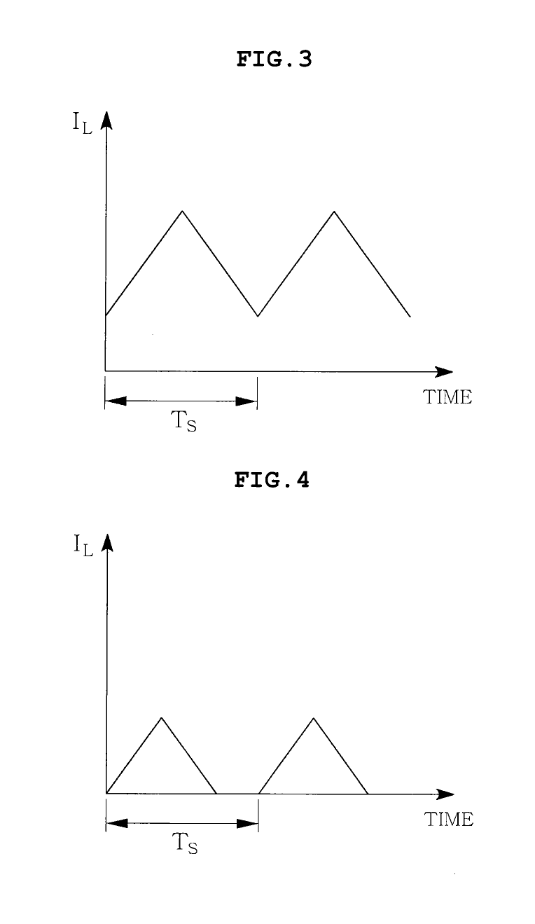

As shown in FIG. 3, current continuously flows via the inductor L31 for a period Ts, which is referred to as a continuous current mode (CCM) and as shown in FIG. 4, current continuously flow via the inductor L for a period Ts is partially blocked, which is referred to as a discontinuous current mode (DCM).

When the power factor calibration circuit 13 is operated as the continuous current mode, if the switching transistor Tr31 is turned-on, current flows via the switching transistor Tr31 from the AC-DC converter 12 and is accumulated in the electromagnetic field of the inductor L31, as described above.

In this case, when the output voltage from the power factor calibration circuit 13 is smaller and smaller over time, the discontinuous mode in which a reverse current flows via the inductor L31 occurs.

In this case, the power factor calibration circuit controller 18 performs a control to turn-off the switching transistor Tr31, thereby blocking the reverse current flowing via the switching transistor Tr31.

The control of the switching transistor Tr31 by the power factor calibration circuit controller 18 is implemented by the change in duty ratio of a pulse (square wave) signal applied to the base of the switching transistor Tr31, which may be referred to as a pulse width modulation control.

Meanwhile, when power is supplied to the battery 17, the battery 17 status is widely changed from the heavy load status (having a small resistance value) supplied with a large amount of power to the light load status (having a large resistance value) supplied with a small amount of power, such that there is a need for high efficiency in a wide load region.

In this case, the power conversion efficiency (power factor) is more significantly degraded in the light heavy than in the heavy load. The reason is that the switching loss of the switching device, i.e., the switching transistor Tr31 is relatively increased in the entire power consumption.

In the present invention, in order to improve the degradation of the power conversion efficiency according to the load status of the battery 17, the switching operation of the switching transistor Tr31 is controlled by using the frequency modulation scheme changing the switching period according to the load status.

More specifically describing, the power factor calibration circuit controller 18 reduces the switching frequency of the switching transistor Tr31 (i.e., reduces the frequency period of the pulse signal of the switching control signal) when the load resistance is small, that is, the output current is small and thus, reduces the power loss due to the switching operation.

On the other hand, the power factor calibration circuit controller 18 increases the switching frequency (increases the frequency period of the pulse signal of the switching control signal) when the load resistance is large (heavy load) to control the switching operation of the switching transistor Tr31 mainly depending on the pulse width modulation scheme.

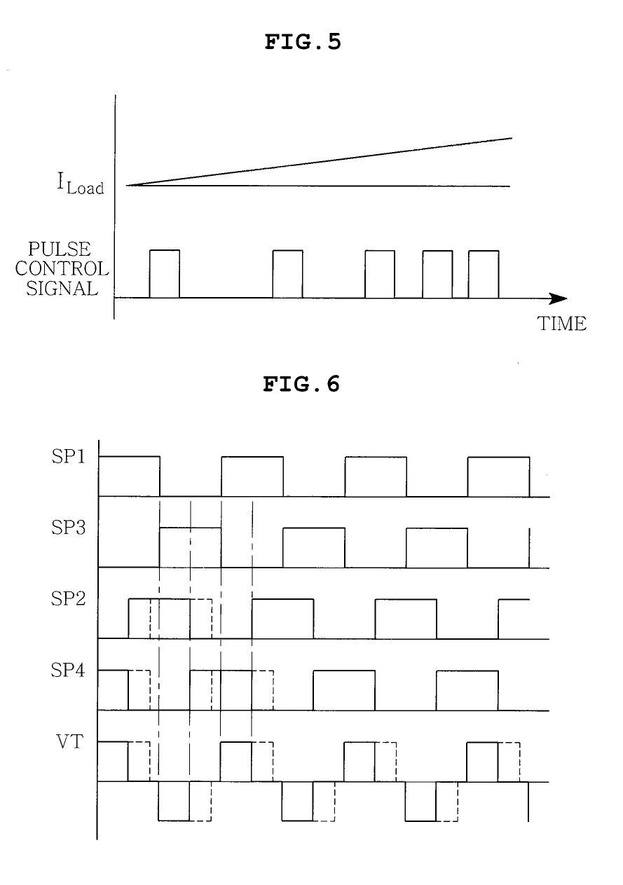

In this connection, FIG. 5 shows the pulse signal output from the power factor calibration circuit controller 18 according to the change in current _{Load} flowing into the battery 17. When current flowing into the battery 17 is increased, the frequency of the output pulse signal is increased.

To the contrary, when the current flowing into the battery 17 is reduced, the frequency of the pulse signal output from the power factor calibration circuit controller 18 is decreased.

Next, the DC-DC converter 14 is configured to include a DC-AC converter 14-1, a contactless transformer 14-2, and an AC-DC converter 14-3.

In this configuration, the DC-AC converter 14-1 is configured to include a pair of switching transistors Tr41 and Tr42 of which the collector is connected to one terminal of the output side of the power factor calibration circuit 13 and the emitter is connected to each of two terminals of the contactless transformer 14-2 and a pair of switching transistors Tr43 and Tr44 of which the collector is connected to each of the two terminals of the contactless transformer 14-2 and the emitter is connected to a terminal of the other side of the power factor calibration circuit 13.

The DC-AC converter 14-1 is configured to include four anti-parallel diodes D41, D42, D43, and D44 reversely connected between the collectors and the emitters of each of the switching transistors Tr41, Tr42, Tr43, and Tr44 in order to prevent current from being reflowing from the winding of the secondary side of the contactless transformer 14-2.

As shown in FIG. 6, the above-mentioned configured DC-AC converter 14-1 supplies AC current such as VT to the winding of the secondary side of the contactless transformer 14-2 by switching the base terminals SP1, SP2, SP3, and SP4 of the four switching transistors.

Meanwhile, the winding of the primary side of the contactless transformer 14-2 is connected to the AC-DC converter 14-1 and the winding of the secondary side thereof is connected to the AC-DC converter 14-3.

In addition, the winding of the primary side of the contactless transformer 14-2 is connected to a resonance inductor L41 and a resonance capacitor C41 in series and can transmit the maximum power according to selection of an appropriate device value.

The contactless transformer 14-2 increases or reduces voltage and current applied to the winding of the primary side thereof according to the winding ratio and transfers it to the winding of the secondary side thereof, such that current is constantly applied to the AC-DC converter 14-3.

The AC-DC converter 14-3 is configured as a bridge full-wave rectification circuit in which four diodes D45, D46, D47, and D48 are connected in a bridge scheme. If a positive current is applied to a first terminal c, the first and fourth diodes D45 and D48 are turned-on to pass through the positive current and if a negative current is applied to a second terminal d of the bridge circuit, the second and third diodes L46 and L47 are turned-on to pass through the negative current.

Therefore, when the load is connected across the bridge full-wave rectification circuit of the AC-DC converter 14-3, i.e., between the first terminal c and the second terminal d, the current passing through the bridge circuit constantly flows from the first terminal c into the second terminal d at all times.

Next, the charging filter unit 15 includes a capacitor C51 connected between both terminals of the DC-DC converter 14 in parallel and an inductor L51 connected to one terminal of the DC-DC converter 14 in series.

The capacitor C51 and the inductor L51 forms a band pass filter, thereby removing and passing through the interference and noise of the unnecessary high frequency signal of the DC power output from the DC-DC converter 14.

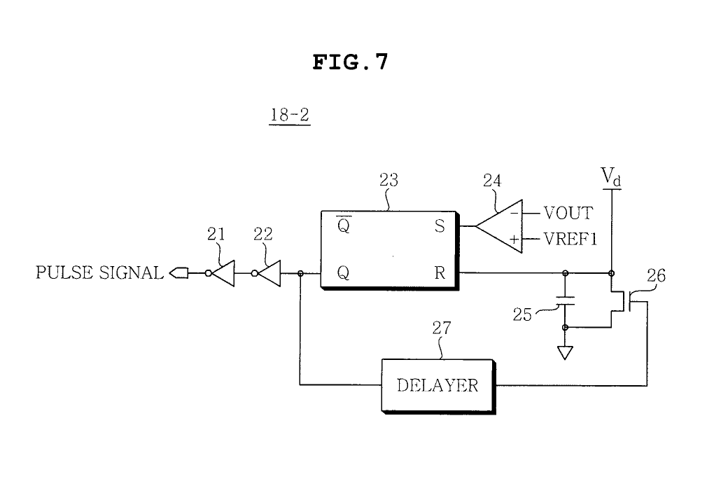

FIG. 7 is a diagram showing the pulse frequency modulator shown in FIG. 1.

Referring to FIG. 7, the pulse frequency modulator includes inverters 21 and 22, a latch 23, a comparator 24, a capacitor 25, an NMOS transistor 26, and a delayer 27.

The comparator 24 receives output voltage VOUT and reference voltage VREF1 output in proportion to the load status from the battery management system and outputs comparative signals to an input terminal S of the latch 23. The capacitor 25 is connected between power voltage Vd and ground voltage. The NMOS transistor 26 is connected between the power voltage Vd and the ground voltage and is controlled by the output of the delayer 27.

The latch 23 is configured of an R-S latch and the input terminal S thereof is connected with the comparative signal output from the comparator 24 and the input terminal R thereof is connected with the connection node of the capacitor 25 and the NMOS transistor 26.

The output Q of the latch 28 is supplied to the delayer 27 and the inverter 22. The inverters 22 and 21 are connected with the output Q of the latch 23 in series to output the pulse signal.

As set forth above, the present invention controls the power factor calibration circuit with the variable frequency according to the load status of the battery, thereby constantly keeping the power factor while the status of the battery is changed from the heavy load to the light load.

Further, the present invention controls the power factor calibration circuit with the variable frequency according to the load status of the battery, thereby making it possible to reduce the switching loss and the power consumption.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Accordingly, such modifications, additions and substitutions should also be understood to fall within the scope of the present invention.

What is claimed is:

1. A charging equipment of variable frequency control for power factor, comprising:
an AC-DC converter receiving AC power and converting it into DC power and outputting it;
a power factor calibration circuit including a switching device and calibrating the power factor of the DC power output from the AC-DC converter by the switching operation of the switching device and outputting it;
a DC-DC converter converting DC power output from the power factor calibration circuit into DC power for charging a battery and outputting the converted DC power; and
a power factor calibration circuit controller performing the switching control by varying the frequency of the pulse signal according to a load status of a battery output from a battery management system when performing a switching control on the switching devices of the power factor calibration circuit by modulating a pulse width of a pulse signal according to the DC power output from the power factor calibration circuit.

2. The charging equipment of variable frequency control for power factor as set forth in claim 1, wherein the power factor calibration circuit controller varies the frequency of the pulse signal in order to have a switching frequency relatively lower in a heavy load status than in a case where the load status of the battery is in a light load status.

3. The charging equipment of variable frequency control for power factor as set forth in claim 1, wherein the power factor calibration circuit controller includes:
a pulse width modulator outputting a pulse signal of which the pulse width is modulated in order to perform a switching control on the switching device of the power factor calibration circuit; and
a pulse frequency modulator varying a frequency of the pulse signal output from the pulse width modulator according to the load status of the battery output from the battery management system to perform the switching control on the switching device.

4. The charging equipment of variable frequency control for power factor as set forth in claim 3, wherein the pulse frequency modulator includes:
a comparator receiving output voltage and reference voltage in proportion to the load status from the battery management system to compare the input signals and output them;
a transistor having a first terminal connected to power voltage and a second terminal and a third terminal connected to ground voltage;
a capacitor connected between the first and second terminals of the transistor in parallel;
a latch connected to the output terminal of the comparator and the first terminal of the transistor and outputting the pulse signal of which the frequency is varied; and
a delayer delaying the pulse signal of which the frequency is varied to provide it to the third terminal of the transistor.

5. The charging equipment of variable frequency control for power factor as set forth in claim 1, further comprising a filter unit receiving the AC power to remove high frequency component and output it to the AC-DC converter.

6. The charging equipment of variable frequency control for power factor as set forth in claim 1, further comprising a charging filter unit receiving the DC power output from the DC-DC converter to remove the high frequency component and output it to the battery.

7. The charging equipment of variable frequency control for power factor as set forth in claim 1, wherein the AC-DC converter includes a bridge full-wave rectification circuit in which four diodes are connected in a bridge scheme.

8. The charging equipment of variable frequency control for power factor as set forth in claim 1, wherein the power factor calibration circuit includes:
an inductor connected to one terminal of the AC-DC converter in series;
a blocking diode connected to the inductor in series in a positive direction toward a load terminal and blocking current in a reverse direction;
a switching transistor having a first terminal connected to the output terminal of the inductor and a second terminal connected to the other terminal of the AC-DC converter and performing a function as the switching device by performing the turn-on/off operation according to the switching control signal applied through the third terminal from the power factor calibration circuit controller; and
a storage capacitor connected between the output terminal of the blocking diode and the other terminal of the AC-DC converter.

9. The charging equipment of variable frequency control for power factor as set forth in claim 1, wherein the DC-DC converter includes:
a DC-AC converter converting DC power output from the power factor calibration circuit into AC power;
a contactless transformer increasing and reducing AC power output from the AC-DC converter and outputting the AC power; and
an AC-DC converter converting the increased or reduced AC power output from the contactless transformer into DC power for the battery and outputting the converted DC power.

10. The charging equipment of variable frequency control for power factor as set forth in claim 9, wherein the DC-AC converter includes:
a pair of switching transistors having a first terminal connected to one terminal of the output side of the power factor calibration circuit and a second terminal connected to each of the two terminals of the contactless transformer;
another pair of switching transistors having a first terminal connected to each of the two terminals of the contactless transformer and a second terminal connected to the other side terminal of the power factor calibration circuit; and
four anti-parallel diodes reversely connected between the first terminal and the second terminal of each of the switching transistors in order to prevent current from reflowing from the winding of the secondary side of the contactless transformer.
